(19) United States
(12) Patent Application Publication
(10) Pub. No.: US 2009/0200890 A1
(43) Pub. Date: Aug. 13, 2009

(54) Winding For An Axial Gap Electric Dynamo Machine

(75) Inventor: Richard Halstead, Rohnert Park, CA (US)

Correspondence Address: EDWARD S. SHERMAN, ESQ., 3554 ROUND BARN BLVD., SUITE 303, SANTA ROSA, CA, 95403, US

(73) Assignee: EMPIRE MAGNETICS INC., Rohnert Park, CA (US)

(21) Appl. No.: 12/368,083

(22) Filed: Feb. 9, 2009

Related U.S. Application Data
(60) Provisional application No. 61/027,471, filed on Feb. 10, 2008.
(60) Provisional application No. 61/027,465, filed on Feb. 10, 2008.

(51) Int. Cl. H02K 3/28; H02K 15/04

(52) U.S. Cl. 310/208; 29/596

(57) ABSTRACT

The stator of an axial gap dynamoelectric machine has at least one substantially planar coil arrays formed by joining two or more sub-coils. Each sub-coil has a serpentine path about the stator perimeter that includes radial segments disposed to generate a Lorenz force with respect to the rotor magnets. The radial segments of the serpentine path joined by alternating inner and outer tangential segments. Each sub-coil starts with a proximal end at an outer tangential segments and a distal end about or within an inner perimeter of the inner tangential segments. Each sub-coil is joined at the distal end with another sub-coil to form the winding coil such that the proximal ends of the sub-coils constitute the two terminals of the planar coil array. This arrangement conveniently places both terminals of the planar coil array at the outer perimeter of the stator while also raising the winding inductance to a level more compatible with conventional motor power supplies.

### CROSS REFERENCE TO RELATED APPLICATIONS

This application claims priority to the US Provisional Patent that was filed on Feb. 10, 2008, having application Ser. No. 61/027,471, which is incorporated herein by reference.

This application also claims priority to the US Provision Patent that was filed on Feb. 10, 2008, having application Ser. No. 61/027,465, which is incorporated herein by reference.

### BACKGROUND OF INVENTION

The present invention relates to axial gap dynamo electric machines and more particularly in improvements of the windings thereof.

Prior methods axial gap electric dynamo machines (EDM's), that is motors and generators, require a different winding pattern than more conventional radial EDM's. The winding and assembly of the segments adds significantsly to the cost of making such EDM's.

It is therefore a first object of the present invention to provide a simpler and more cost effective method of assembling the stators of axial gap dynamoelectric machine for use as generators and motors, and in particular for wind power generation of electricity.

### SUMMARY OF INVENTION

In the present invention, the first object is achieved by providing an axial gap dynamo electric machine, the machine comprising an axle, at least one rotor disk in rotary co-axle connection to said axle and having at the periphery thereof an array of permanent magnets with each magnetic having an alternating orientation of the poles with respect to the adjacent magnets in the array, a stator disk having disposed co-axially about said axle and supporting one or more electrically energizable planar coil arrays that comprises a plurality of dual layer coils segments, the coils segments being mirror images with an electrical junction at inner diameter of the coil, each dual layer coil having an electrical junction to the adjacent dual coil segment at the outer diameter of the coil.

The above and other objects, effects, features, and advantages of the present invention will become more apparent from the following description of the embodiments thereof taken in conjunction with the accompanying drawings.

### BRIEF DESCRIPTION OF THE DRAWINGS

FIG. 1A is a cross-sectional elevation of an axial gap EDM according to one embodiment of the invention.

FIG. 1B is an enlarged view of a portion of the preferred embodiment of the winding of the stator coil in FIG. 1A.

FIG. 2A is a plan view of two sub-coils showing the direction of current flow.

FIG. 2B is a radial cross-section through the two sub-coils to show the junction between them and the direction of current flow.

FIG. 2C is a radial cross-section through the two sub-coils after joining to show the junction between them and the direction of current flow.

FIG. 2D is a plan view of two sub-coils after joining to show the junction between them and the direction of current flow.

FIG. 2E is a tangential elevation of the sub-coils of FIG. 2B from outside of the stator in showing the direction of current flow, at section line E-E in FIG. 2C.

FIG. 3 is a plan view of one embodiment of the stator disk for the EDM.

FIG. 4 is a plan view of a second embodiment of the stator disk for the EDM.

FIG. 5 is a plan view of a third embodiment of the stator disk for the EDM.

FIG. 6A-C illustrate an alternative method of forming the coils of the stator disk.

### DETAILED DESCRIPTION

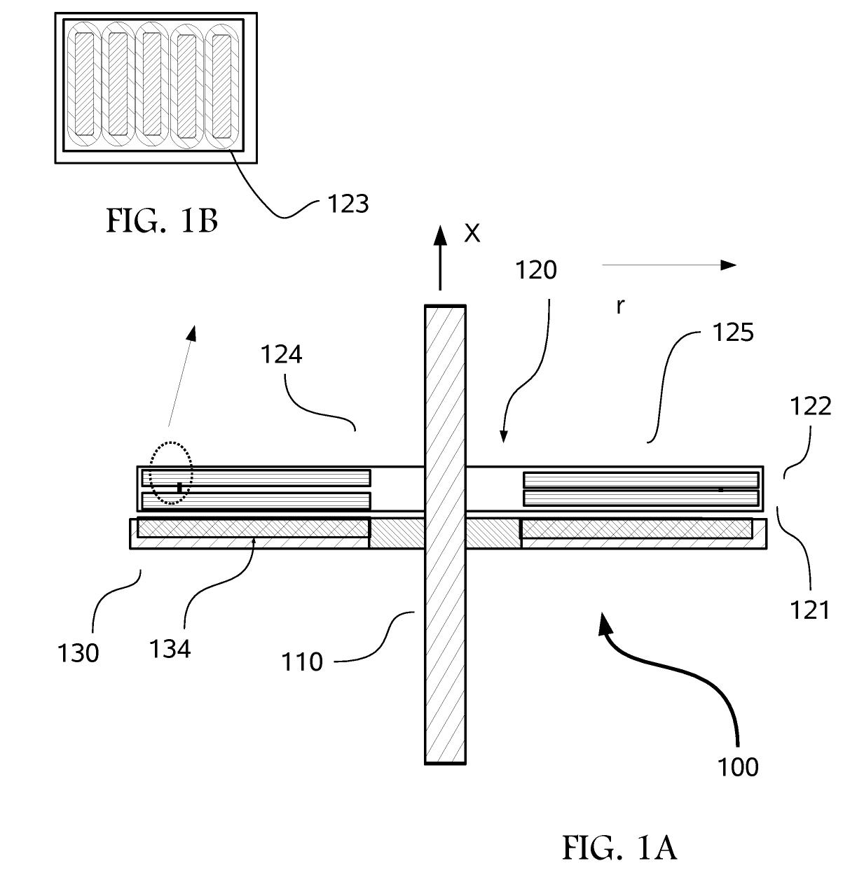

Referring to FIGS. 1 through 6, wherein like reference numerals refer to like components in the various views, there is illustrated therein a new and improved axial gap EDM, generally denominated 100 herein.

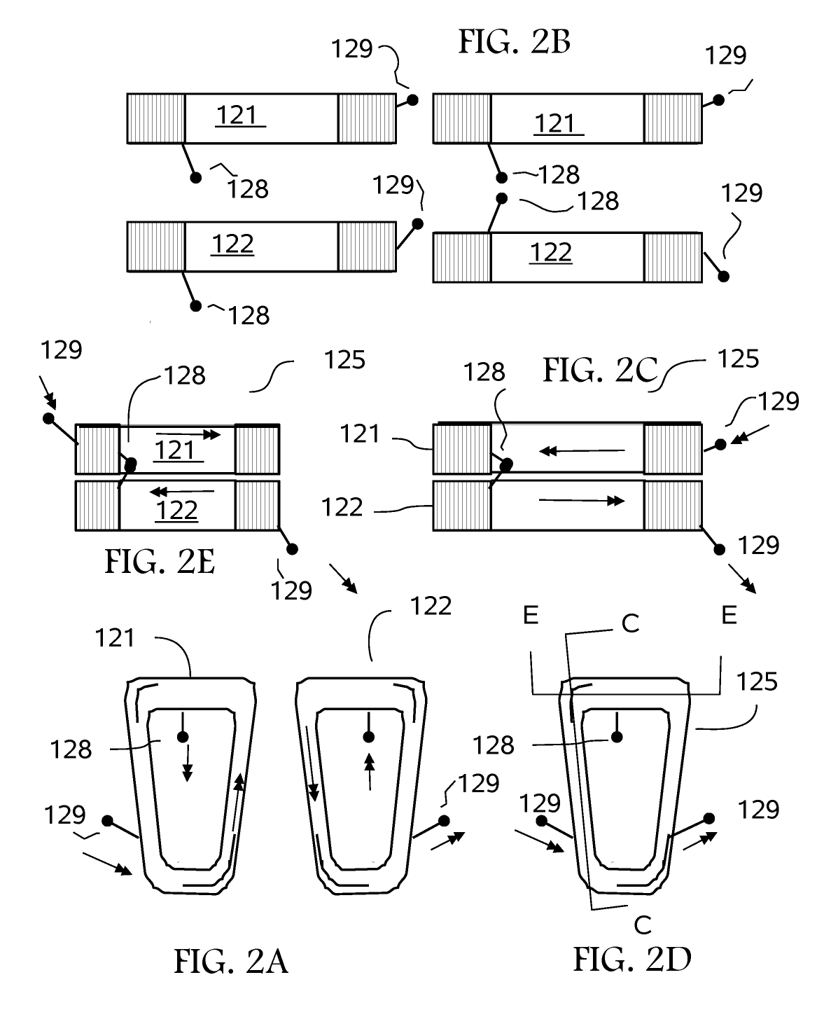

The coordinate system for FIG. 1 and 2 is non-orthogonal and circular, with the x-direction being the long axis of rotor axle 110, redirection being the radial direction of the stator disk 120 and rotor disk 130, and the t-direction being tangential to the stator disk 120 and rotor disk 130.

FIG. 1A-B illustrate that primary components of the axial gap EDM 100, having an axle 110 coupled to a rotor disk 130 with permanent magnets 131 radially arrayed at the periphery thereof. Each of the permanent magnets 131 is disposed with an alternating orientation of its poles with respect to the adjacent magnets in the array, it will be appreciate by one familiar with the construction of motors that the stator disk 120 is generated supported or attached to the motor housing and the axle 110 is confined for free rotation of the axle axis by rotary type bearings that are also attached or couple to the motor housing. As the motor housing and bearings are generally conventional in the art, they are omitted from the Figures for simplicity of illustration.

However, in a more preferred embodiments, the outer periphery of the rotor 130 is supported by a magnetic bearing, as for example in the magnetic bearing system disclosed in U.S. Provision Patent Appl. No. 61/027,465 filed on Feb. 10, 2008, which is incorporated herein by reference.

A stator disk 120 is not connected to the axle 110, but is disposed parallel and adjacent to the rotor disk 130, with the axle 110 freely passing through the open center of the stator disk 120. The stator disk 120 has at least one substantially planar coil array 124 formed thereon or attached thereto. Each planar coil arrays 124 is formed first by winding insulated wire 123 into a sub coil such as 121 and 122. Each sub coil preferably has a trapezoid shape with rounded corners, as shown in FIG. 2A, with a wire terminus at the inside 128 and the outside 129 of the sub coil. The narrower side of the trapezoid shape is disposed toward the center of the stator disk 120, increasing the density of current that generates a Lorentz force when the EDM 100 is deployed as a motor or in a current generating capacity when the EDM 100 is deployed as a generator.

Two identical sub coils 121 and 122 are joined by flipping over the first of the two sub coils, aligning it up above or below the other sub-coil and attaching them electrical in communication at the adjacent inner terminals 128, in which the sub coils are stacked to form a double layered winding segment 125. It should be noted, as shown by the double headed arrows indicating the direction of current flow in FIG. 2A-C that one sub coil 122 effectively spirals clockwise, while the other sub coil 121 spirals counterclockwise so that the current in each coil is effectively flowing in the same direction with respect to the Lorenz force it would generate on the rotor magnets 131. Preferably the planar coil array 124 includes a plurality of the double layered winding segments 125, which are arrayed about the center of the stator disk 120 through which axle 110 passes.

As shown in FIG. 2D, each double layered winding segment 125 has two electrical terminals 129 and 129′ on the outside of the stacked sub coils 121 and 122. Placing the electrical terminals on the outside of winding segment 125 minimized the cap that would be created by a crossing wire, increasing the Lorentz force. It was surprising found that when the gap is minimize to 1-2 mils (25-50 microns) the inductance increases by a factor of 4. Further, when the axial gap dynamoelectric machine is a motor, the higher inductance of the stator winding permits the use of conventional power supplies, reducing the cost of the completed and operative motor.

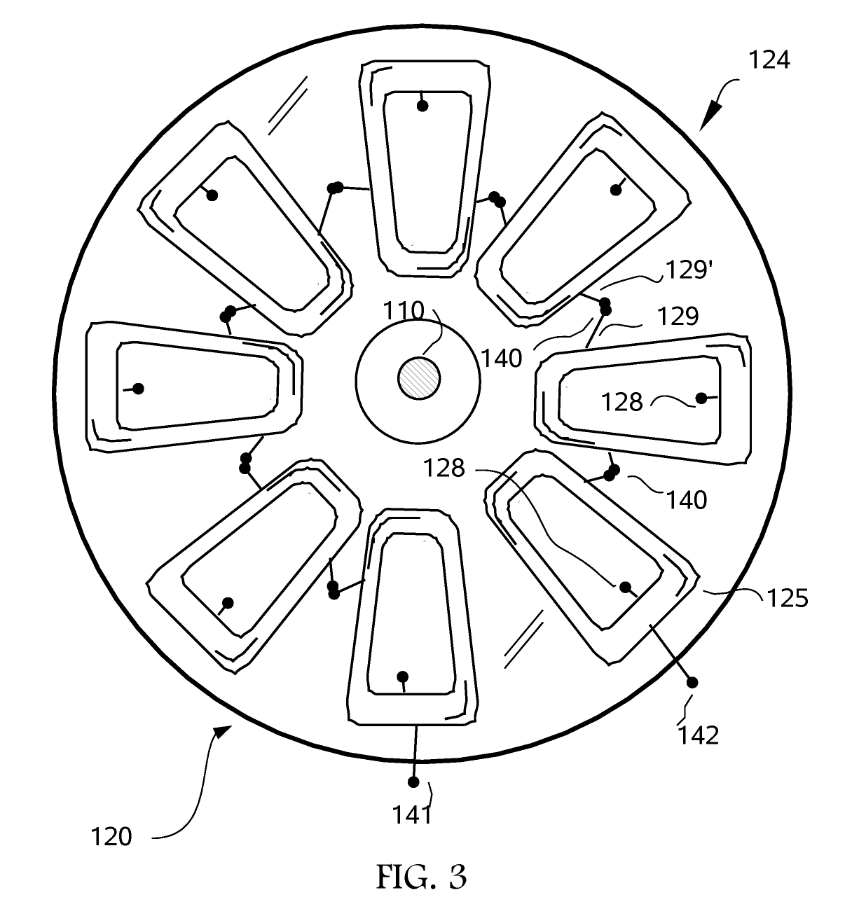

As shown in FIG. 3-5, the adjacent outer terminals 129′ of one sub coil connected to outer terminal 129 of the adjacent sub coil in electrical communication to form junctions 140 of planar coil array 124. Multiple planar coil arrays 124 can be overlaid or placed adjacent, to complete the petal arrangement, each being powered or tapped as a different phase, depending on the EDM's 100 use as motor or generator. As the winding segments 125 can also be arrayed on staggered sides of the stator disk 120, the term planar array means at some of the segments 125 are either in a common plan or adjacent parallel plane.

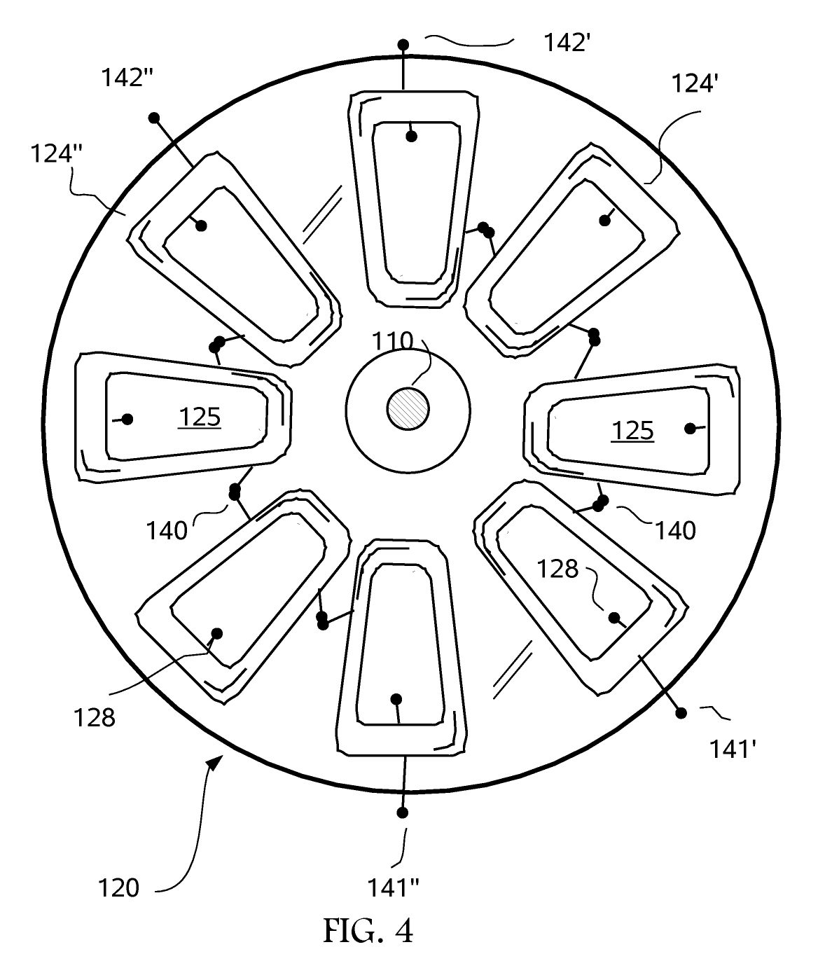

Thus, in the non-limiting examples shown in FIG. 3 and FIG. 4 two or more winding segments 125 are optionally arrayed like flower petals about axle 110 being laterally and radially separated to corresponding to the stator 120 diameter and the magnet placement on the rotor 130. In FIG. 3 all winding segments 125 are connected to form a single planar coil array 124. In contrast, in FIG. 4, half of the winding segments 125 form a first planar coil array 124′, with the other half connected to form the second planar coil array 124″.

In FIG. 3, this arrangement conveniently places both terminals 141 and 142 of the planar coil array 124 at the outer perimeter of the stator while also raising the winding inductance to a level more compatible with conventional motor power supplies.

In FIG. 4, the first planar coil array 124′ has terminals 141′ and 142″ conveniently placed at the outer perimeter of the stator, but on opposite sides. Further, the second planar coil array 124″ has terminals 141″ and 142″ conveniently placed at the outer perimeter of the stator, but on opposite sides. However, it should be appreciated that the terminals 129 and 129′ of each winding coil 129 can be placed anywhere on the winding coil, thus allowing the placement of terminals 141 and 142 in the various embodiments at any convenient or advantageous location on the stator disk 120.

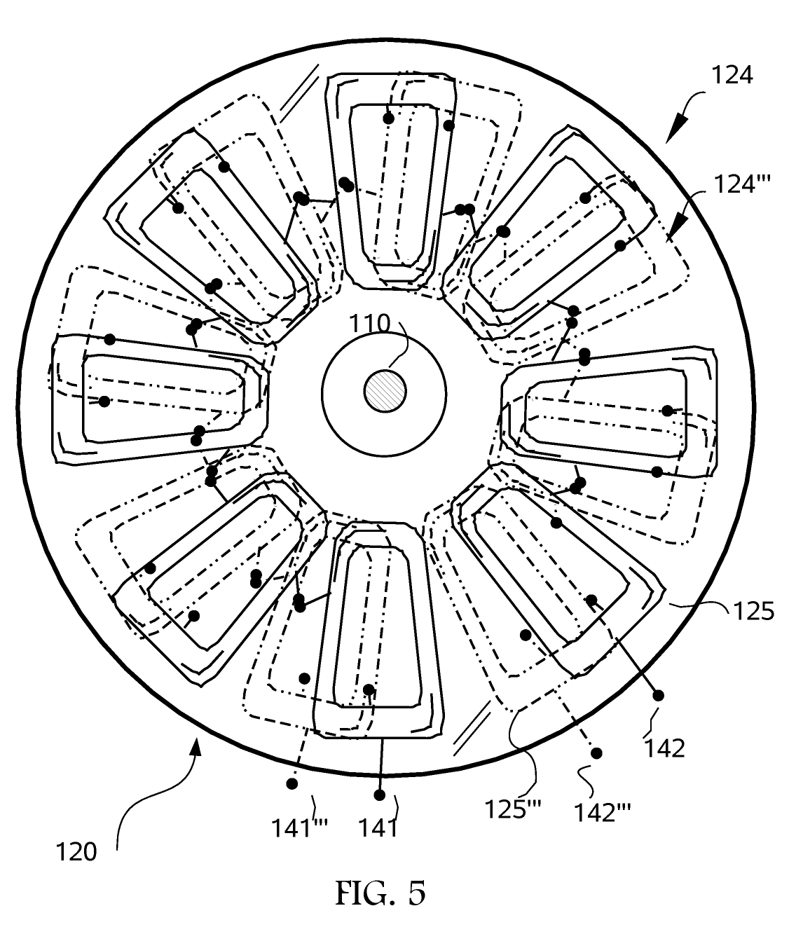

In other embodiments multiple planar coils arrays 124 can be partially overlapped and nested by at least partially deforming the in tangentially segments of the winding plane to maximize packing with a minimum gap between the rotor and stator rotors. As for example, in FIG. 5, a first planar array 124 and a second planar array 124′″, each comprise 8 coil winding segments 125, that extend around the entire periphery of stator disk 120, disposing terminal 141 and 142 ( for array 124) adjacent. The second planar array 124′″ is shown in dot-dash lines, and is rotated by about 22.5° with respect to array 124 about axle 110, thus nesting the tangential segments of each winding segment 125 within the other, 125′″, of the second planar coil array.

It will also be appreciated by one of ordinary skill in the art that such an axial gap EDM 100 typically includes a plurality of rotors 120 and stator 130, or may have two stator 130 disposed on opposite sides or a rotor 120, as well as the opposite configuration, as the rotor 130 or stator 120 may have magnets as well as windings on both sides.

The various means for forming coil segments 125, such as winding flat wire on a stack in a trapezoidal mandrel, as well as forming planar coils arrays 124 and arranging them on the stator 120 provide a simpler and more cost effective method of assembling the stators of axial gap dynamoelectric machine for use as generators and motors, and in particular for wind power generation of electricity.

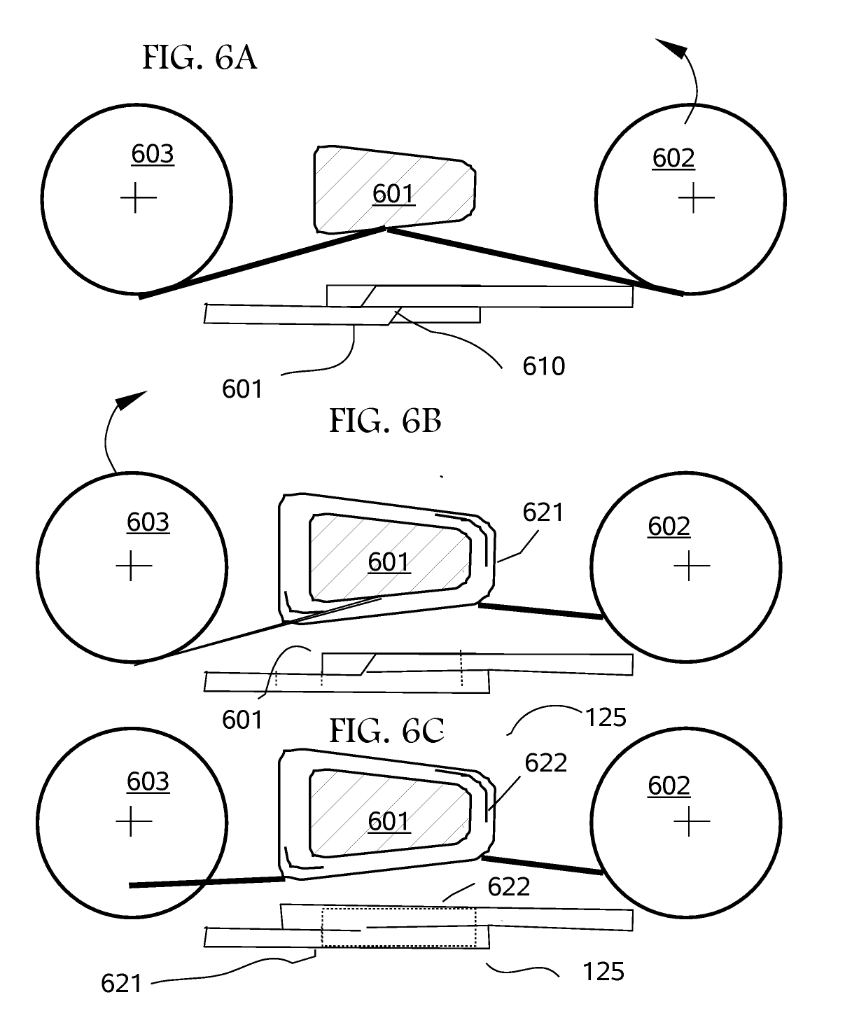

It should be appreciated however that the upper and lower coils 121 and 122 need not be formed separately and then connected at common terminals 128. In contrast the functional equivalent coil 125 can be formed by from a single run of flat cable by winding from the middle thereof by first folding the flat cable twice at 610, in FIG. 6. The folds provides a short continuous flat cable segment that runs perpendicular to the winding direction between the upper and lower sub coils 621 and 622, which are preferably sequential wound from spools or coils that hold opposite side of the flat conductor. FIG. 6A-C illustrates this method of forming such a coil segment 125 where the coils of flat wire 602 and 603 are sequentially wrapped around the rounded trapezoidal mandrel 601, being formed of single length of flat cable. Thus, FIG. 6A shows an elevation on which coils 602 and 603 are circular, but offset by the width of the flat conductor which is folded twice, at 450 in each layer as shown in the adjacent plan view from below as they are temporally attached to mandrel 601. The first coil 602 is wound counter clockwise as shown by the arrow in FIG. 6A, laying the flat cable around the mandrel 601 forming sub coil 621. Then in FIG. 6B, the second coil 603 is wound clockwise as shown by the arrow, laying the flat cable around the adjacent portion of mandrel 601 forming sub coil 622. Thus, as shown in FIG. 6C, dual coil segment 125 results, being supported on mandrel 601, it should be appreciated that as an alternative to this embodiment, the mandrel can be rotated instead of the coils 602 and 603, that is in a first stage in one direction to wrap the conductive wire in coil 602 in one direction, and then in the opposite direction to wrap the conductive wire in coil 602. However, in doing so only one coil should be allowed to unwind conductor wire, with the opposite coil being fixed to the rotary axis of mandrel 601 and rotating around it without dispensing conductive wire.

It should be appreciated that it is preferred, though not essential, that the wire 123 that forms the coil is a flat conductor, and that more specifically that the flat conductor has at least a 4:1 aspect ratio. The wide side of the flat conductor lies perpendicular to the common winding plane, of stator 120, to maximize the number of coil turns. It should also be appreciated that although the insulated wires shown in FIG. 1C are flat ribbons to form a rectangular bundle, they are optionally of any rectangular or circular cross section and may be packed in a rectangular, circular, oblong or a bundle of any shape.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

1. An axial gap electric dynamo machine (EDM), the machine comprising:
a) an axle,
b) at least one rotor disk in rotary co-axle connection to said axle and having at the periphery thereof an array of permanent magnets with each magnetic having an alternating orientation of the poles with respect to the adjacent magnets in the array,
c) a stator disk disposed parallel and adjacent to said rotor disk with said axle freely passing through the center thereof, said stator disk supporting one or more electrically energizable planar coil arrays that comprises;
i) a plurality of substantially coplanar dual layer coils segments, the coil segments in each layer being mirror images of the other layer and connected at a common electrical junction at the inner diameter of the dual layer coil segment,
ii) a first terminal to one of the coil segments being disposed at the outer diameter of the dual layer coil segment, and
iii) a second terminal to the other coil segment being disposed at the outer diameter of the dual layer coil segment,
d) wherein the first terminal of all but one of the dual coil segments in said plurality is connected to the second terminal of the adjacent dual coil segment, to provide each of the one or more planar coil arrays with a first and second terminals for external connection to a power source or to tap power from the EDM.

2. An axial gap electric dynamo machine according to claim 1 further comprising a plurality of electrically energizable planar coil arrays.

3. An axial gap electric dynamo machine according to claim 1 wherein the electrically energizable planar coil array circumscribes the entirety of the stator disk so as to dispose the first and second terminals for external connection on adjacent coil segments.

4. An axial gap electric dynamo machine according to claim 2 wherein each of the electrically energizable planar coil arrays of said plurality of electrically energizable planar coil arrays are powered or tapped at a different phase.

5. An axial gap electric dynamo machine according to claim 2 wherein at least one electrically energizable planar coil arrays is nested within another electrically energizable planar coil arrays.

6. An axial gap electric dynamo machine according to claim 5 wherein at least one electrically energizable planar coil arrays has at least a portion of one of tangential or radially disposed portion deformed out of the plane of the stator disk to provide space for nesting tangential portion of the coils array in a common plane.

7. An axial gap electric dynamo machine according to claim 2 wherein 2 or more of the plurality of electrically energizable planar coil arrays are disposed on opposite sides of the stator.

8. An axial gap electric dynamo machine according to claim 2 wherein 2 or more of the plurality of electrically energizable planar coil arrays extend only partially around the stator disk.

9. An axial gap electric dynamo machine according to claim 1 the wire that forms the coil is a flat conductor having its principle plane disposed perpendicular to the stator disk.

10. An axial gap electric dynamo machine according to claim 7 wherein the flat conductor has at least a 4:1 aspect ratio.

11. A method of forming a dual layer coil for an axial gap electric dynamo machine, the method comprising the steps of:
a) providing at least one substantially trapezoidal mandrel and a least one wire conductor,
b) winding the wire conductor around the at least one substantially trapezoidal mandrel to form an upper coil having inner and outer terminal ends,
c) winding a wire conductor around the at least one substantially trapezoidal mandrel to form a lower coil having inner and an outer terminal ends,
d) overlaying the upper and lower coils,
e) joining the inner terminal of the first coil to the inner terminal of the second coil in electrical communication such that current flowing into the outer terminal of one coils will flow in the opposite direction in the other coil.

12. A method of forming a dual layer coil for an axial gap electric dynamo machine according to claim 11 wherein each coil is separately wound and then joined to the other coil.

13. A method of forming a dual layer coil for an axial gap electric dynamo machine according to claim 11 wherein the upper and lower coils are wound sequentially on the same mandrel, wherein the winding of the upper coil and the lower coil are in opposite directions.

14. A method of forming a dual layer coil for an axial gap electric dynamo machine according to claim 13 wherein said step of the joining occurs after the winding the or either the upper or the lower coil and before winding the other coil.

15. A method of forming a dual layer coil for an axial gap electric dynamo machine, the method comprising the steps of:
a) providing at least one substantially trapezoidal mandrel and a least one wire conductor,
b) attaching the wire conductor to the mandrel
c) winding the at least one wire conductor in a first stack of layers around the substantially trapezoidal mandrel in a first direction to form a first coil having at least an outer terminal end,
d) winding the at least one wire conductor in a second stack of layers around the at least one substantially trapezoidal mandrel in a second direction opposite the first direction to form a second coil having at least an outer terminal end.

16. A method of forming a dual layer coil for an axial gap electric dynamo machine according to claim 15 wherein the first and second coils are wound simultaneously on the same mandrel.

17. A method of forming a dual layer coil for an axial gap electric dynamo machine according to claim 15 wherein each of the first and second stack of layers have an inner terminal end adjacent the mandrel.

18. A method of forming a dual layer coil for an axial gap electric dynamo machine according to claim 17 wherein the inner and outer terminal ends of the first and second stack of layers are joined prior to winding.

19. A method of forming a dual layer coil for an axial gap electric dynamo machine according to claim 15 wherein the first and second coils are formed from the same length of wire conductor.

20. A method of forming a dual layer coil for an axial gap electric dynamo machine according to claim 19 wherein the first and second coils are wound adjacent to each other being connected by a length of the wire conductor that is folded at least twice to run between the first and second stack of layers adjacent to the mandrel, being disposed perpendicular to the wire that comprises the first and second coils.
